(19) United States
(12) Patent Application Publication
(10) Pub. No.: US 2019/0205848 A1
(43) Pub. Date: Jul. 4, 2019

(54) INTERNET-BASED ATM MANAGEMENT SYSTEM

(71) Applicant: Manish Puri, Marietta, GA (US)

(72) Inventor: Manish Puri, Marietta, GA (US)

(21) Appl. No.: 15/856,339

(22) Filed: Dec. 28, 2017

(51) Int. Cl. G06Q 20/10

(52) U.S. Cl. CPC G06Q 20/1085

(57) ABSTRACT

An Internet-based automated teller machine (ATM) management system is provided. The ATM management system is disposed between the ATM users operatively associated with ATM accounts and the ATM processors operatively associated with Independent Sales Organizations (ISO's). The ATM management system provides request management functionality coupling the ATM users and the ISO's. The request management functionality enables ATM users to provide request data reviewable and approvable by the ISO prior to the request data being entered into the respective ATM accounts of the ATM processor. The present invention maps the request data for representation on user interfaces of both the ATM users and the ISO's.

### BACKGROUND OF THE INVENTION

The present invention relates to automated teller machines (ATM's) and, more particularly, to an Internet-based ATM management system.

Currently, merchants and Independent ATM Distributors (IADs) have limited control over their ATM accounts, specifically to make necessary administrative changes needed in their operations. ATM processors have direct relationships with registered Independent Sales Organizations (ISO's), thereby causing ISO's to make data entries to satisfy Merchant and IAD requests. Due to ISO's security concerns, merchants and IADs do not have the ability to generate new ATM Id requests or make administrative changes to their ATM accounts directly through their ATM processors.

The existing systems give the ISO's control to make changes to ATM accounts. If merchants and IADs were granted access, such access would pose security problems for the ISO's because currently ISO's are held liable for erroneous or fraudulent entries by its customers. The current systems have no ticketing or request management ability to act as a layer of protection for the ISO's while enabling the merchants and IADs to make their entries.

As can be seen, there is a need for an Internet-based ATM management system having ticketing or request management ability which acts as a layer of protection for the ISO while enabling merchants and IADs to make ATM Id requests and administrative changes directly to their ATM accounts.

The present invention maps all administrative data entry requests made by its customers, enabling merchants and IAD's to make operational and administrative changes to their accounts, while affording their sponsoring ISO liability protection as proposed change request s are authored by its customers and ISO's just need to either approve or decline the change requests.

### SUMMARY OF THE INVENTION

In one aspect of the present invention, a computer environment-based ATM management system for users of ATM accounts of an ATM processor having independent sales organizations, including a request management functionality operatively associating first user interfaces of the users, second user interfaces of the independent sales organizations, and the ATM processor in a computer environment; the request management functionality configured to receive request data via the first user interfaces and representing said request data on the second user interfaces; and the request management functionality configured to prompt the second user interface to approve or decline each request data.

In another aspect of the present invention, the computer environment-based ATM management system for users of ATM accounts of an ATM processor having independent sales organizations, including a request management functionality operatively associating first user interfaces of the users, second user interfaces of the independent sales organizations, and the ATM processor in a computer environment; and a first database coupled to the first user interfaces for retrievably storing request data received from each first user interface, wherein the request data comprises ATM Id requests or make administrative changes; the request management functionality configured to perform the following: receive said request data via the first user interfaces and representing said request data on the second user interfaces; prompt the second user interface to approve or decline each request data, wherein the request management functionality is configured to transmit each approved request data to the ATM processor for synching thereto; and map each request data on the first user interfaces, wherein the independent sales organizations are not held liable for each approved request data.

These and other features, aspects and advantages of the present invention will become better understood with reference to the following drawings, description and claims.

### BRIEF DESCRIPTION OF THE DRAWINGS

FIG. 1 is a schematic view of an exemplary embodiment of the present invention;

FIG. 2 is a schematic view of an exemplary embodiment of the present invention;

FIG. 3 is a schematic view of an exemplary embodiment of the present invention;

FIG. 4 is a schematic view of an exemplary embodiment of the present invention;

FIG. 5 is a schematic view of an exemplary embodiment of the present invention;

FIG. 6 is a schematic view of an exemplary embodiment of the present invention, and a continuation of FIG. 5;

FIG. 7 is a schematic view of an exemplary embodiment of the present invention, and a continuation of FIG. 6; and

FIG. 8 is a schematic view of an exemplary embodiment of the present invention.

### DETAILED DESCRIPTION OF THE INVENTION

The following detailed description is of the best currently contemplated modes of carrying out exemplary embodiments of the invention. The description is not to be taken in a limiting sense, but is made merely for the purpose of illustrating the general principles of the invention, since the scope of the invention is best defined by the appended claims.

Broadly, an embodiment of the present invention provides an Internet-based ATM management system disposed between the ATM user and the current ATM processing system, wherein the Internet-based ATM management system provide request management functionality that the ATM users and the ISO's of the ATM processing system are operatively associated. The request management functionality enables ATM users to provide request data reviewable and approvable by the ISO before request data is entered into the respective ATM accounts. The present invention maps the request data for representation on user interfaces of both the ATM users and ISO's.

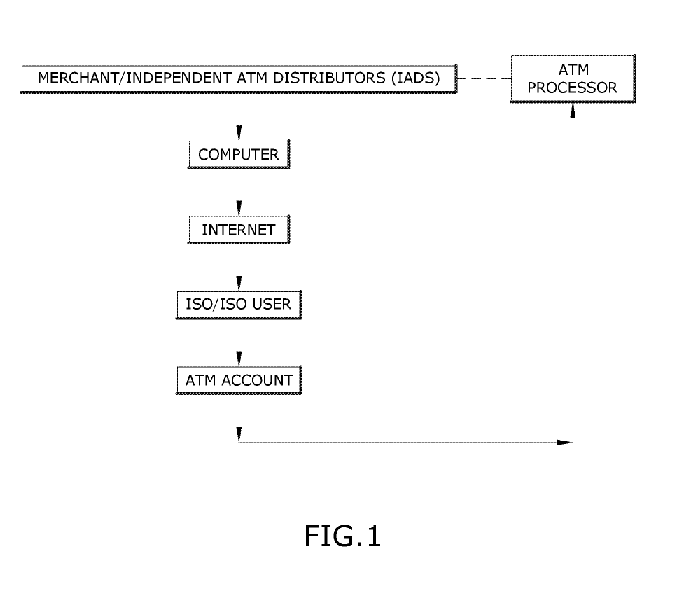

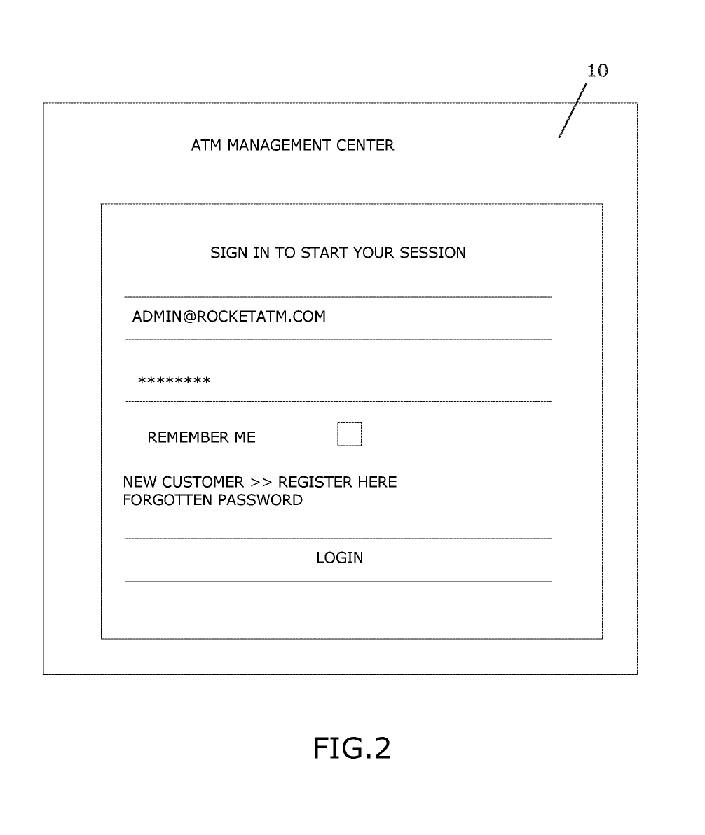

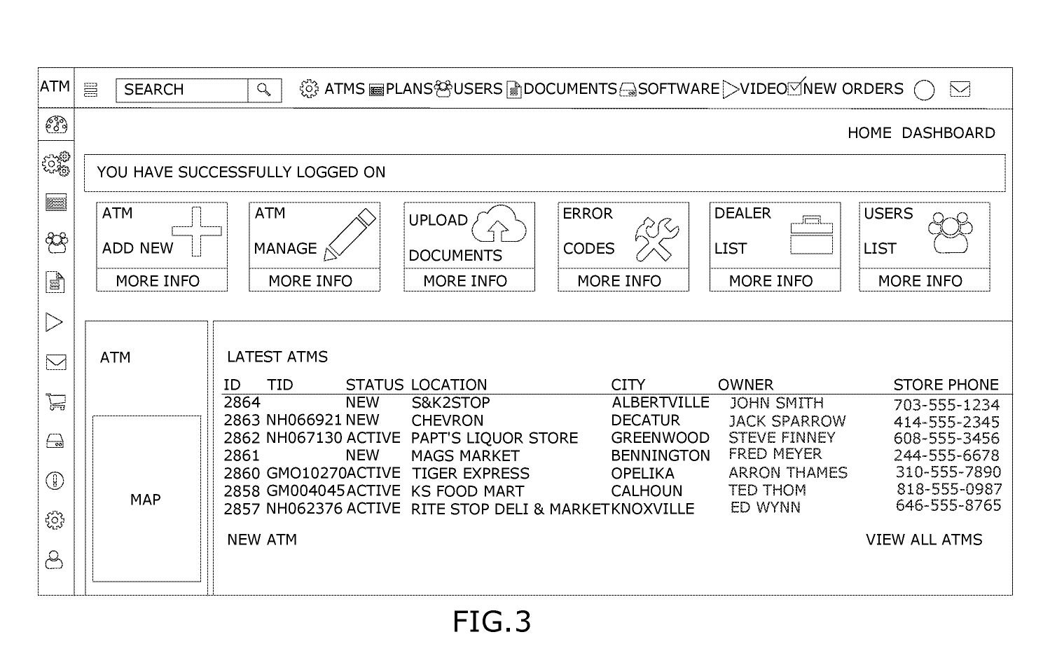

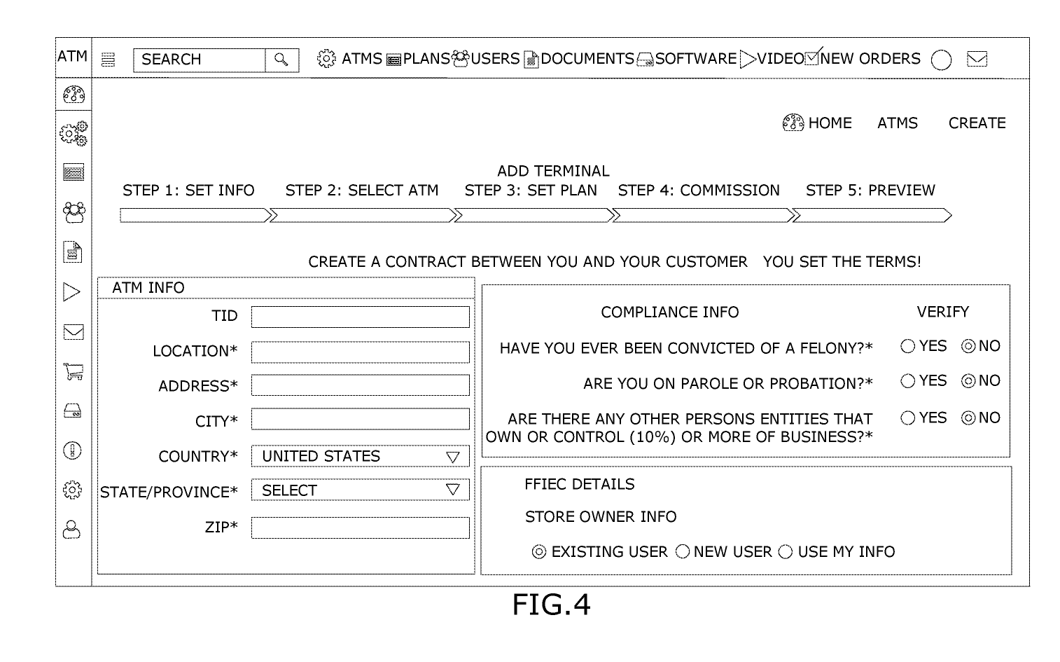

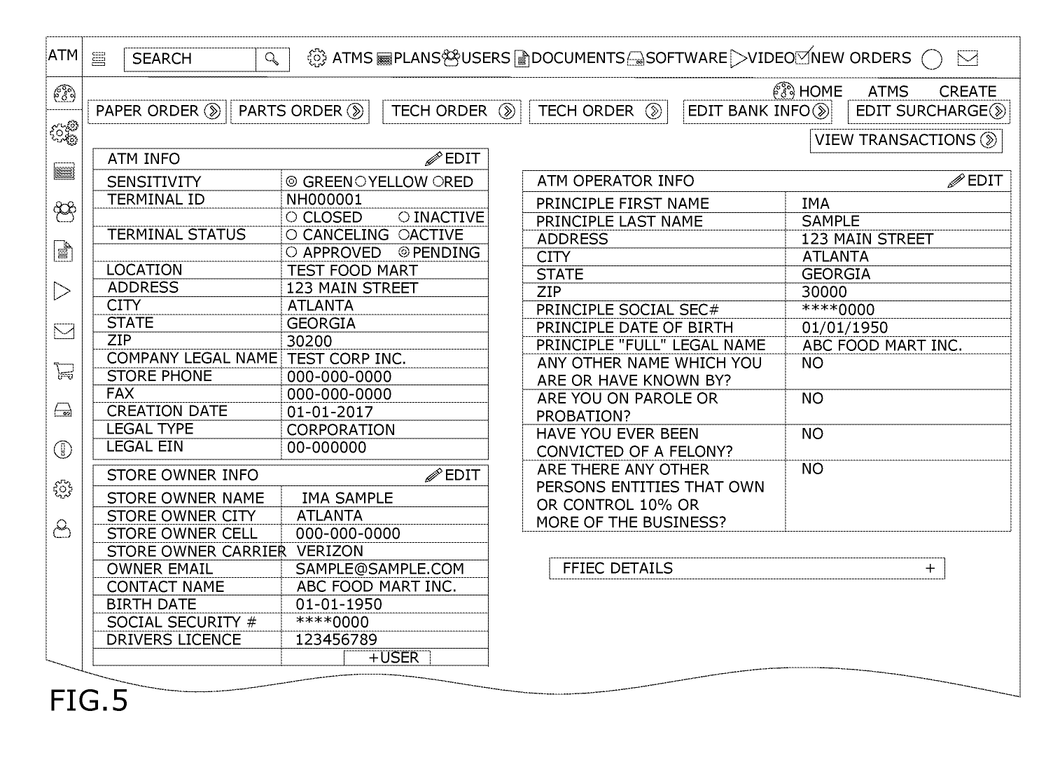

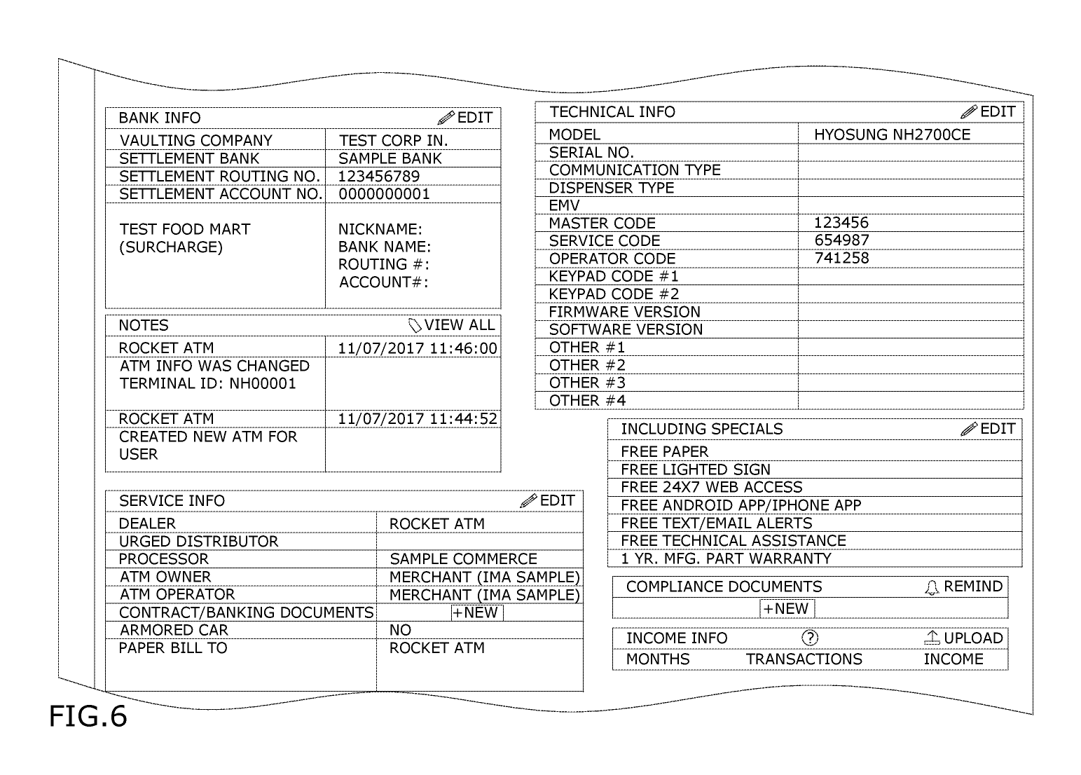

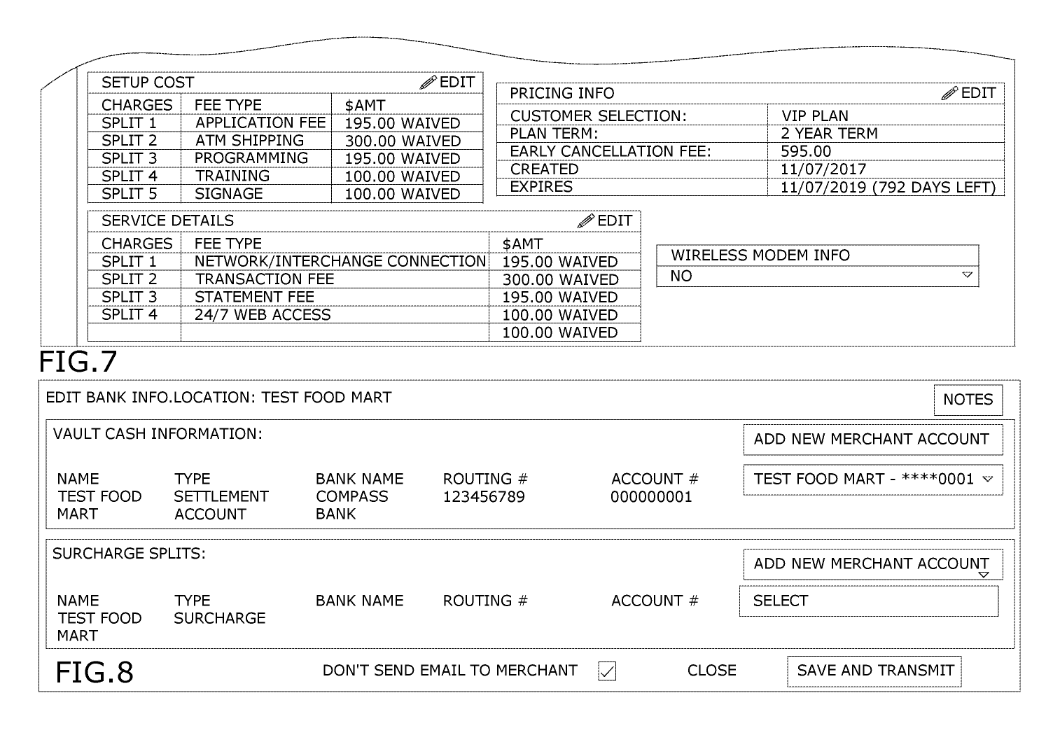

Referring to FIGS. 1 through 8, the present invention may include at least one computer with a user interface 10 and operably associated input/output devices, peripherals, and the like, such as at least one monitor, a keyboard, a mouse or other manually operable interface for controlling on-screen cursor activity of the user interface 10. The computer may include at least one processing unit and a form of memory including, but not limited to, a desktop, laptop, and smart device, such as, a tablet and smart phone. The computer may include a program product including a machine-readable program code for causing, when executed, the computer to perform steps. The program product may include software which may either be loaded onto the computer or accessed by the computer. The loaded software may include an application on a smart device. The software may be accessed by the computer using a web browser using the internet, extranet, intranet, host server, internet cloud or similar computing environments.

At least one computer may be operatively associated with a first database adapted to retrievably store demographic, personal, financial, and other request data. The at least one computer may be operatively associated with ISOs and ATM users, for example by way of the computer environment. ATM users may be customers, merchants and IAD's associated with ATM accounts. The present invention may be embodied in a software application loaded on the computer and adapted to receive request data from a plurality of ATM users as well as send such request data as messages, entries, to-do requests and the like to the associated ISOs.

Via their operatively associated user interfaces 10, ATM users may monitor their request data (messages, entry requests, and the like), such as ATM ID requests and administrative changes orders, facilitating the ATM users' control over their ATM accounts.

On the ISO's side, the software application may provide the ISOs functionality via their operatively associated user interface 10 for viewing such request data from ATM users for their ATM accounts. The present invention enables the ISO's to view and approved or decline the content-data (again, an entry request for example) prior to their transmission to or final entry in the ATM processor systems of the ISO's (e.g., prior to effectuating the final data entry of the entry request and synching of supplied request data into the ATM account). Thereby facilitating security control for the ISO's over the ATM processors administrative systems, because the request data (entry requests) was provided by the ATM users and not the ISO's, hence eliminating the latter's liability for any errors, mistakes or omissions.

In certain embodiments, a synched connection between the ATM user and the ATM processor systems may be provided, whereby the ISO's actions would consist of only providing approval or declination, like a gateway/switch, as opposed to a separate node.

A method of using the present invention may include the following. The Internet-based ATM management system disclosed above may be provided. An ATM user may transmit request data, viewable over their user interface 10, to an operatively associated ISO, providing the ATM user a measure of control over their ATM account. The ISO receives the request data via their user interface 10, and is enabled to approve or decline the request data prior to its entry into the underlying ATM processing system, whereby the operatively associated ISO maintains security control over the access of the ATM processing system, while eliminating liability arising from any entered request data.

The computer-based data processing system and method described above is for purposes of example only, and may be implemented in any type of computer system or programming or processing environment, or in a computer program, alone or in conjunction with hardware. The present invention may also be implemented in software stored on a computer-readable medium and executed as a computer program on a general purpose or special purpose computer. For clarity, only those aspects of the system germane to the invention are described, and product details well known in the art are omitted. For the same reason, the computer hardware is not described in further detail. It should thus be understood that the invention is not limited to any specific computer language, program, or computer. It is further contemplated that the present invention may be run on a stand-alone computer system, or may be run from a server computer system that can be accessed by a plurality of client computer systems interconnected over an intranet network, or that is accessible to clients over the Internet. In addition, many embodiments of the present invention have application to a wide range of industries. To the extent the present application discloses a system, the method implemented by that system, as well as software stored on a computer-readable medium and executed as a computer program to perform the method on a general purpose or special purpose computer, are within the scope of the present invention. Further, to the extent the present application discloses a method, a system of apparatuses configured to implement the method are within the scope of the present invention.

It should be understood, of course, that the foregoing relates to exemplary embodiments of the invention and that modifications may be made without departing from the spirit and scope of the invention as set forth in the following claims.

What is claimed is:

1. A computer environment-based ATM management system for users of ATM accounts of an ATM processor having independent sales organizations, comprising:
a request management functionality operatively associating first user interfaces of the users, second user interfaces of the independent sales organizations, and the ATM processor in a computer environment;
the request management functionality configured to receive request data via the first user interfaces and representing said request data on the second user interfaces; and
the request management functionality configured to prompt the second user interface to approve or decline each request data.

2. The system of claim 1, wherein the request management functionality is configured to transmit each approved request data to the ATM processor.

3. The system of claim 1, wherein the request management functionality is configured to synch each approved request data to the ATM processor.

4. The system of claim 1, wherein the request management functionality is configured to map each request data on the first user interfaces.

5. The system of claim 1, wherein the request data comprises ATM Id requests or make administrative changes.

6. The system of claim 1, wherein the independent sales organizations are not held liable for each approved request data.

7. The system of claim 1, further comprising a first database coupled to the first user interfaces for retrievably storing the request data received from each first user interface.

8. A computer environment-based ATM management system for users of ATM accounts of an ATM processor having independent sales organizations, comprising:
a request management functionality operatively associating first user interfaces of the users, second user interfaces of the independent sales organizations, and the ATM processor in a computer environment; and
a first database coupled to the first user interfaces for retrievably storing request data received from each first user interface, wherein the request data comprises ATM Id requests or make administrative changes;
the request management functionality configured to perform the following:
receive said request data via the first user interfaces and representing said request data on the second user interfaces;
prompt the second user interface to approve or decline each request data, wherein the request management functionality is configured to transmit each approved request data to the ATM processor for synching thereto; and
map each request data on the first user interfaces,
wherein the independent sales organizations are not held liable for each approved request data.
